(19) United States
(12) Patent Application Publication
(10) Pub. No.: US 2006/0013923 A1
(43) Pub. Date: Jan. 19, 2006

(54) Method and device for making stuffed tofu

(76) Inventor: Kung-Shen Lo, Taipei Hsien (TW)

Correspondence Address: PRO-TECHTOR INTERNATIONAL, 20775 Norada Court, Saratoga, CA, 95070-3018, US

(21) Appl. No.: 10/891,158

(22) Filed: Jul. 13, 2004

(51) Int. Cl. A23G 3/00

(52) U.S. Cl. 426/91

(57) ABSTRACT

The present invention provides a method and a device for making stuffed tofu. The device for making stuffed tofu has a bar to hold the stuffed material and a container with a compartment. The compartment has a recess for receiving the bar. The compartment has a volume larger than the volume of the stuffed material. The method for making stuffed tofu has steps of attaching a stuffing material onto a bar, inserting one end of the bar into the recess so that the stuffing material on the bar is placed within the compartment, immersing soybeans in water and grinding the soybeans, adding water to the soybeans to form a soybean magma,then boiling the soybean magma, cooling the soybean magma and adding the coagolator to the soybean magma to form lactary soybean, pouring the lactary soybean into the clearance between the wall of the compartment and the stuffing material and coagulating the lactary soybeanto become tofu.

### BACKGROUND OF THE INVENTION

1. Field of the Invention

The present invention relates to a method and a device for making stuffed tofu, and more particularly to a method and a device for making stuffed tofu, which are able to secure the stuffing material inside the tofu.

2. Description of Related Art

Normally, when a material is to be stuffed inside a food, the user slides a slit in the food and then inserts the material into the food for cooking. However, when the stuffed food is being cooked, the stuffed material may fall out of the food, which causes a lot of trouble for the user. Especially, the stuffed material after falling out of the food may stain the pot and spoil the entire dish.

In order to overcome the shortcoming, inventions have been implemented by using sophisticated machine to ensure the stuffing material from falling out of the food during cooking process. However, all these improvements are only suitable for large scale machine for mass production and require a lot of investment, which are all not suitable for making stuffed tofu.

Besides, tofu is a very special material for making stuffed food. This is because that when the lactary soybean is being coagulated of solidified, there must be no oil in it. If there is a little oil in lactary soybean, it will not be coagulated or solidified to become tofu. In the normal progress of making tofu, the following steps are included:
1. immersing soybeans in water for 8-12 hours;
2. grinding the soybean;
3. adding a volume of water that is 4-6 times the volume of the soybeans to the soybeans so as to form a soybean magma;
4. boiling the soybean magma for 3-5 minutes;
5. mixing the coagulator with the hot(about 70° C.) soybean magma to form a lactary soybean; and
6. cooling the lactary soybean and then the lactary soybean will become tofu.

However, the lactary soybean will not become tofu if the maker makes stuffed tofu according to the above method. Because the oil of the stuffing will come into the lactary soybean. The material of the stuffing is often beef, pork, fish, meat or the mixture thereof. The oil of these food stuffs will come out and come into the soybean magma when they meet the hot soybean magma. In the general and faulty progress of making molded and stuffed tofu, the following steps are included:
1. immersing soybeans in water for 8-12 hours;
2. grinding the soybeans;
3. adding a volume of water that is 4-6 times the volume of the soybeans to the soybeans so as to form a soybean magma;
4. boiling the soybean magma for 3-5 minutes;
5. mixing the coagulator with the hot (about 70° C.) soybean magma to form a lactary soybean;
6. positioning a stuffing into a mold;
7. pouring the lactary soybean which still hot into the container to surround the stuffing; and
8. cooling the said lactary soybean around the stuffing.

By the above method, we still can not get stuffed tofu. The lactary soybean which is mixed with coagulator with the stuffing can not coagulate. The physical properties and chemical reaction of tofu are the reasons.

The physical properties are that the lactary soybean is liquid and the tofu is solid. The liquid lactary soybean and the solid tofu are the same material. When the lactary soybean is poured into the container, it is desired to be liquid; but when the stuffed tofu is taken out of the container, it is desired to be solid.

The chemical reaction will happen when we mix the coagulator with the soybean magma. The protein of soybean will agglomerate. The protein is especially glycinin. The lactary soybean is the mixture of soybean magma and the coagulator. And then we cool the lactary soybean. The liquid lactary soybean will become solid. This solid material is what we call tofu.

Only the hot liquid lactary soybean can be poured into the container. The cool and solid tofu can not pour into the container. And a conflicting problem will happen. The maker want the liquid lactary soybean but the maker don't want it hot. The heat of liquid lactary soybean will let the oil of stuffing come out and come in to the liquid lactary soybean. The oil of the stuffing will change the chemical reaction between the coagulator and the soybean magma. The result is that the oil of the stuffing let the liquid lactary soybean can not coagulate to become solid tofu. So the maker can not get the stuffed tofu.

In view of Mitchell et al(GB '140), Mitchell et al(GB '140) althought discloses positioning a stuffing material onto at lease one bar so that both ends of the bar extend from the stuffing material,selecting a container with at lease one compartment,placing the bar with the stuffing material in the compartment of the container,inputting a second coagulable or solidifiable material into the container to surround the stuffing material and removing the stuffing material with the solidified material around the stuffing material from the container while leaving the bar embedded in the stuffing material. The present invention differs from Mitchell et al in that the stuffing material having oil in itselfe, the oil stop the coagulation of lactory soybeam and the bar is placed in a recesss in the container.

As reference to Schnaier ('612), it is notoriously old to place a moldable food support stick into a recess of the mold to provide handles at both ends of the food after the food is molded. But we can not get-molded and stuffed tofu by the method of Mitchell et al, the oil of the stuffing destroy the coagularion of lactary soybean. The lactary soybean is liquid state. Liquid coagulates solid. The solid state of lactary soybean is called the soybean curd or tofu. So can the lactary soybean not coagulate,so can the maker not get the stuffed tofu

To overcome the shortcomings, the present invention intends to provide an improved method and device for making stuffed tofu to mitigate or obviate the aforementioned problems.

### SUMMARY OF THE INVENTION

The primary object of the invention is to provide a method and a device for making stuffed tofu. The secondary object of the invention is to provide a convenience food of stuffed tofu. Another object of the invention is to provide a device for making molded tofu with stuffing in it.

In order to accomplish the above objects,the present invention provides a method for making stuffed tofu comprising the following steps:
1. attaching a stuffing material onto at lease one bar so that both ends of the said bar extent from the stuffing material;
2. providing a container with at least one compartment therein, each compartment having a recess;
3. inserting one end of the bar into the recess so that the stuffing material on the bar is placed within the compartment;
4. immersing soybeans in water for 8-12 hours;
5. grinding the soybean;
6. adding a volume of water that is 4-6 times the volume of the soybean to the soybean so as to form a soybean magma;
7. boiling the said soybean magma for 3-5 minutes;
8. cooling the said soybean magma and then adding coagulator to form lactary soybean; and
9. pouring the lactary soybean into the clearance between the wall of the compartment and the stuffing material so that the stuffing material is wrapped in the lactary soybean.

In the above method, the coagulator is selected from the group consisting of bittern, gluconolactone, Chlorocalcium and gypsum,wherein the bittern is the mixture of Sulfuric Magnesium, Chloropotassium, and Chlorosodium, the molecular formula of the gluconolactone is 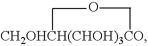
the molecular formula of Chlorocalcium is CaCl₂ and the molecular formula of the gypsum is CaSO₄.2H₂O, The molecular formula of the Sulfuric Magnesium is preferably MgSO₄. The molecular formula of the Chloropotassium is preferably KCl. The molecular formula of the Chlorosodium is preferably NaCl.

Another object of the invention is to provide a device for making stuffed tofu which comprises at least one bar, a container with a recess defined in a bottom face of the container for positioning the bar and a cover for covering the container.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the device for making stuffed tofu of the present invention;

FIG. 2 is a perspective view of the container of the device in FIG. 1, wherein the container is reversed for clear observation;

FIG. 3 is a schematic view showing that the bars are provided with stuffed material and ready to be placed in compartments of the container;

FIG. 4 is a schematic view showing that the bars are placed inside the container;

FIG. 5 is a schematic view showing that lactary soybean is poured in each of the compartments of the container;

FIG. 6 is a schematic view showing that the lactary soybean surrounds the stuffed material and is cooled down to solidify the lactary soybean;

FIG. 7 is a perspective view of the device with a cover;

FIG. 8 is an exploded perspective view of a second embodiment of the present invention;

FIG. 9 is a schematic view showing that the bar of the second embodiment is provided with the stuffed material;

FIG. 10 is a schematic view showing that the bar with the stuffed material is placed inside the container of the second embodiment;

FIG. 11 is a schematic view showing that the lactary soybean is poured into the container of the second embodiment;

FIG. 12 is a schematic view showing that the lactary soybean surrounds the stuffed material and is cooled down to solidify the lactary soybean;

FIG. 13 is a perspective view showing another embodiment of the present invention, wherein the container is shaped like a fish to indicate the ingredient of the tofu made; and

FIG. 14 is a perspective view showing still another embodiment of the present invention, wherein the container is shaped like a cow to indicate the ingredient of the tofu made.

### DETAILED DESCRIPTION OF PREFERRED EMBODIMENT

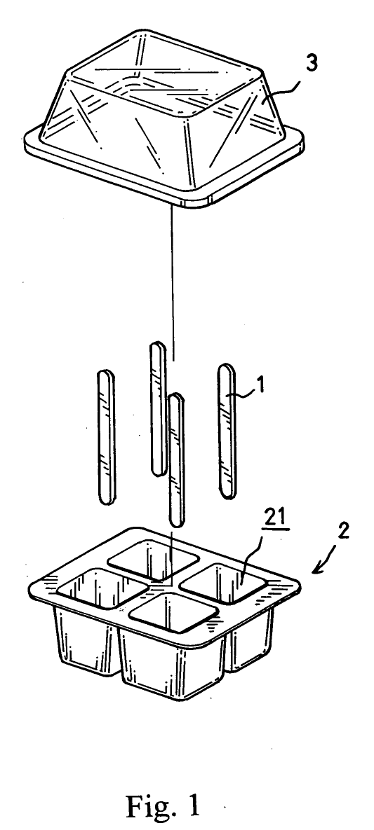

With reference to FIG. 1, the device for accomplishing the objective of the present invention comprises at least one bar 1, a container 2 with at least one compartment 21 defined therein and a cover 3 for detachably engaging with the container 2.

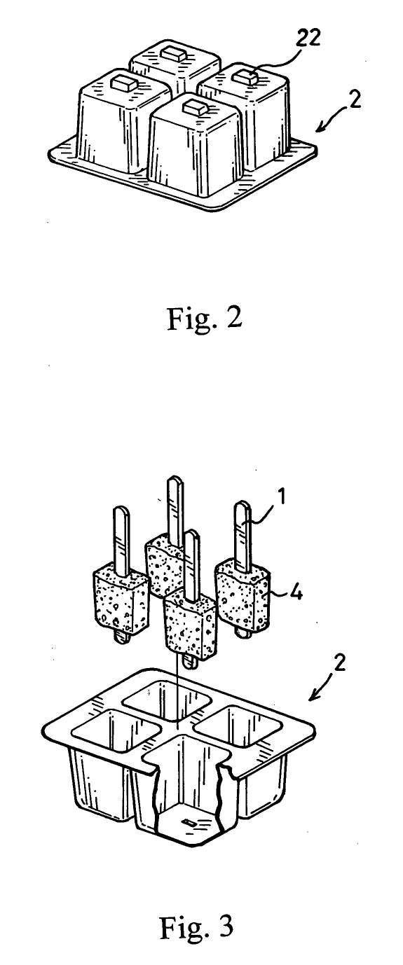

With reference to FIGS. 2 and 3, the at least one compartment 21 has a recess 22 defined in a bottom face defining the compartment 21 to correspond to one of the bars 1. When making the stuffed tofu, the first step is to use any conventional method to securely attach a stuffing material 4 onto the bar 1. It is to be noted that when the stuffing material 4 is attached to the bar 1, both ends of the bar 1 are left with an appropriate length so that after the stuffed tofu is made, the user is able to hole either end of the bar 1.

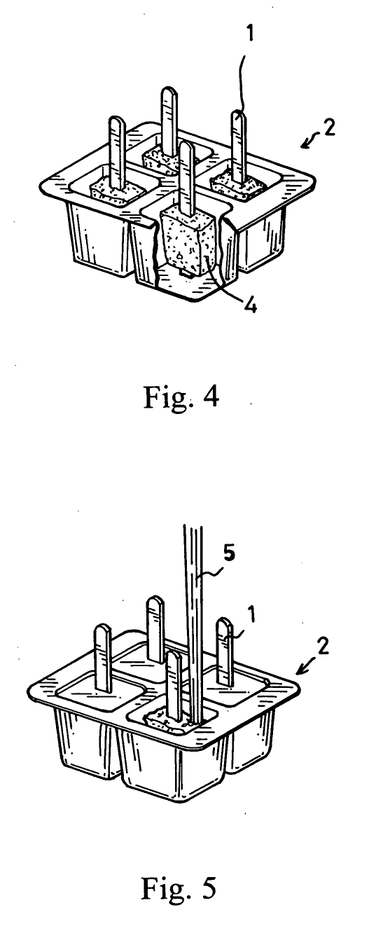

After the stuffing material 4 is securely attached to the bar 1, the user places the bar 1 in the compartment 21 by inserting one of the distal ends of the bar 1 into the recess 22 defined in the compartment 21 of the container 2. However, it should be noted that when the stuffing material 4 is made and attached to the bar 1, the size of the stuffed material 4 is smaller than the volume of the compartment 21 so that after the bar 1 with the stuffing material 4 attached thereon is placed inside the compartment 21, there is still space left in the compartment 21, as shown in FIG. 4.

Thereafter, a suitable quantity of soybean is prepared and immersed in the water for 8-12 hours. The soybean is then removed and ground. After the soybean is ground, 4-6 times of water relative to the volume of the ground soybean is added to make soybean magma. The soybean magma is boiled for 3 to 5 minutes. After filtering and cooling process to the boiled soybean magma, coagulator is added to the soybean magma to form lactary soybean 5.

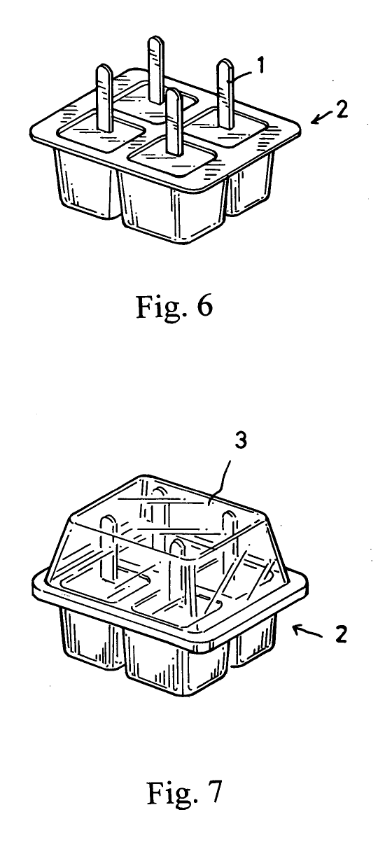

With reference to FIG. 5, after the lactary soybean 5 has been made, the lactary soybean 5 is poured into the compartment 21 with the bar 1 inserted into the recess 22 and the stuffing material 4 securely attached to the bar 1. After the lactary soybean 5 is poured into the compartment 21 and the coagulator is added into the compartment 21, the lactary soybean 5 surrounds the bar 1 and the stuffing material 4. Then, after the lactary soybean 5 has been solidified, the stuffed tofu is made, as shown in FIG. 6.

With reference to FIG. 7,when the stuffed tofu is made, the cover 3 is engaged with the container 2. Thus, the stuffed tofu is ready for use. When the stuffed tofu is eaten, the eater removes the cover 3 and-holds the free end of the bar 1 to remove the bar 1 with the tofu and the stuffing material 4 inside the tofu. After a proper cooking process, the stuffed tofu is edible.

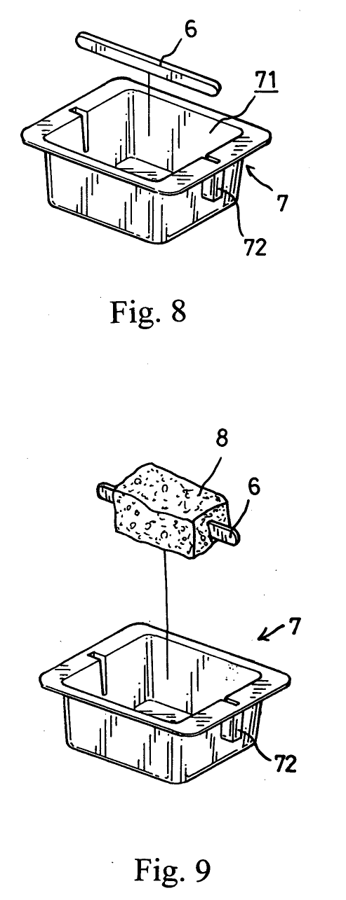

With reference to FIG. 8, the device of the second embodiment comprises at least one bar 6 (only one is shown in FIG. 8), a container 7 with at least one compartment 71 (one is shown in FIG. 8) defined therein and a pair of recesses 72 oppositely defined in a side face defining the compartment 71 to correspond to the bar 6.

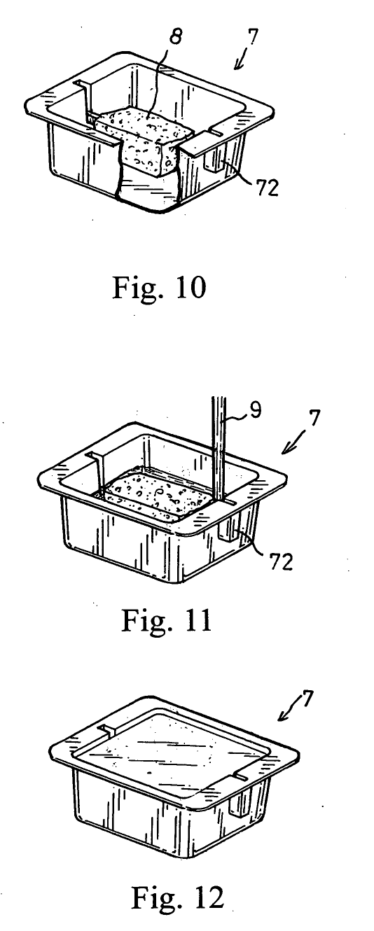

With reference to FIGS. 9 and 10, when making the stuffed tofu, the first step is to use any conventional method to securely attach a stuffing material 8 onto the bar 6. It is to be noted that when the stuffing material 8 is attached to the bar 6, both ends of the bar 6 is left with an appropriate length so that after the stuffed tofu is made, the user is able to hole either end of the bar 6.

After the stuffing material 8 is securely attached to the bar 6, the user places the bar 6 in the compartment 71 by inserting the distal ends of bar 6 into the recesses 72 defined in the compartment 71 of the container 7. However, it should be noted that when the stuffing material 8 is made and attached to the bar 6, the size of the stuffing material 8 is smaller than a volume of the compartment 71 so that after the bar 6 with the stuffing material 8 attached thereon is placed inside the compartment 71, there is still space left in the compartment 71, as shown in FIG. 10.

Thereafter, a suitable quantity of soybean is prepared and immersed in the water for 8-12 hours. The soybean is then removed and ground. After the soybean is ground, 4-6 times of water relative to the volume of the ground soybean is added to make soybean magma. The soybean magma is boiled for 3 to 5 minutes. After filtering and cooling process to the boiled soybean magma, coagulator is added to the soybean magma to form lactary soybean 9.

With reference to FIG. 11, after the lactary soybean 9 is made, the lactary soybean 9 is poured into the compartment 71 with the bar 6 inserted into the recesses 72 and the stuffing material 8 securely attached to the bar 6. After the lactary soybean 9 is poured into the compartment 71 and the coagulator is added into the compartment 71, the lactary soybean 9 surrounds the bar 6 and the stuffing material 8. Then, after the lactary soybean 9 is solidified, the stuffed tofu is made, as shown in FIG. 12.

When the stuffed tofu is made, the cover (not shown in this embodiment) is engaged with the container 7. Thus, the stuffed tofu is ready for use. When the stuffed tofu is eaten, the eater removes the cover and reverses the container 7 with the tofu and the stuffing material 8 inside the tofu. After a proper cooking process, the stuffed tofu is edible.

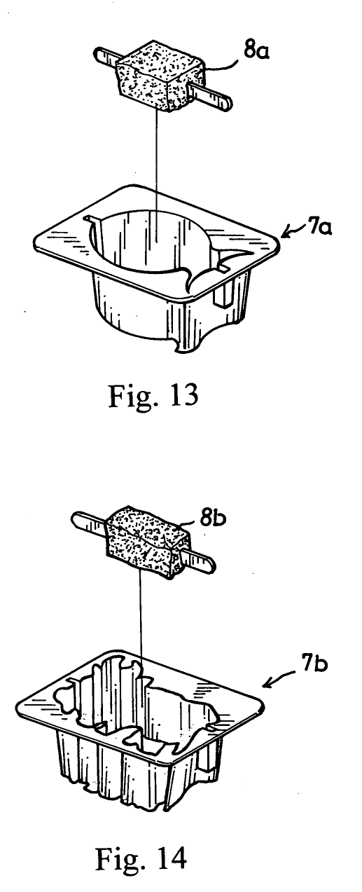

To distinguish the ingredient of the stuffed tofu, the shape of the compartment 2,7 may be made like a fish 7a, as shown in FIG. 13, or a cow 7b, as shown in FIG. 14, so that the eater especially children is able to tell and choice each one from the other ones.

1. A method for making stuffed tofu, comprising the steps of:
(a) attaching a stuffing material securely onto at least one bar so that both ends of said bar extend from said stuffing material;
(b) providing a container with at least one compartment therein, with each compartment having a recess;
(c) inserting one end of said bar into said recess so that said stuffing material on aid bar is placed within said compartment;
(d) immersing soybeans in water for 8-12 hours;
(e) grinding said soybeans;
(f) adding water to said soybeans to form a soybean magma, wherein the volume of said water is 4-6 times that of said soybeans;
(g) boiling said soybean magma for 3-5 minutes;
(h) cooling said soybean magma and then adding a coagulator to said soybean magma to form a lactary soybean;
(i) pouring said lactary soybean into the clearance between the wall of said compartment and said stuffing material so that said stuffing material is wrapped in said lactary soybean;
(j) coagulating said lactary soybean to become tofu; and
(k) taking said bar with said tofu and said stuffing material out of said compartment.

2. The method according to claim 1, wherein said coagulator is selected from the group consisting of bittern, gluconolactone, Chlorocalcium and gypsum.

3. (canceled)

4. (canceled)

5. (canceled)

6. (canceled)

7. (canceled)

8. (canceled)

9. The method according to claim 1, wherein said compartment is shaped like a fish.

10. The method according to claim 1, wherein said compartment is shaped like a cow.
